(19) United States
(12) Patent Application Publication
(10) Pub. No.: US 2015/0357873 A1
(43) Pub. Date: Dec. 10, 2015

(54) MOTORIZED WHEEL

(71) Applicant: AMER S.P.A., Valdagno (IT)

(72) Inventors: Francesco BATTISTELLA, Valdagno (IT); Mirko DALLA COSTA, Schio (IT)

(21) Appl. No.: 14/735,277

(22) Filed: Jun. 10, 2015

(30) Foreign Application Priority Data
Jun. 10, 2014 (IT) PD2014A000143

(51) Int. Cl. H02K 5/04; H02K 7/116

(52) U.S. Cl. CPC H02K 5/04; H02K 7/116

(57) ABSTRACT

A motorized wheel includes an electric motor supported by a fixing bracket. The fixing bracket adapted to rotationally support, by way of elements for reducing the rotation rate, an internally hollow wheel that is contoured to least partly contain the electric motor and said-the rotation rate reduction elements. The electric motor further includes a stator casing, a dome, and a rotor which is internal to the stator casing. The stator is inserted in a corresponding complementarily shaped annular portion that extends from the bracket and is fixed to the bracket by interference.

### FIELD

The present disclosure relates to a motorized wheel.

### BACKGROUND

Currently, floor scrubbing machines, industrial sweepers, electric trucks for transporting loads inside warehouses are usually provided with a plurality of so-called motorized wheels.

FIG. 1 is a sectional view of a conventional motorized wheel, designated therein by the reference letter A.

This motorized wheel A is a motorized wheel comprising an electric motor B, for example, but not exclusively, a direct-current motor, supported by a fixing bracket C, for fixing the motorized wheel to the structure of a truck or a scrubbing machine or another machine that includes it; the electric motor B is adapted to rotate, by way of rotation rate reduction means D, an internally hollow wheel E that is contoured to contain at least partly said electric motor B and the rotation rate reduction means D; the electric motor B comprises, as known, a stator casing F, which supports a plurality of permanent magnets, a brush-holder dome G, and a rotor which is internal to said stator casing F; the shaft H of said rotor is illustrated.

With conventional motorized wheels, usually the dome G and the stator casing F are fixed to an annular portion M of the fixing bracket C by means of threaded elements N, as shown in FIG. 1.

This current solution for the assembly and fixing of the assembly of the brush-holder dome G and the stator casing F to the bracket C by means of screws entails the specific arrangement of the dome component G on which the stator casing F is to be fixed; since said stator casing F is metallic and has to have a precise cylindrical geometry for reasons of magnetic flux containment, it cannot be deformed in order to be fixed directly to the bracket C.

The provision of the adapted brush-holder dome component G and its assembly to the bracket C by means of screws are activities that entail costs both in terms of components and in terms of assembly times, as well as dedicated labor costs.

### SUMMARY

The disclosure provides a motorized wheel capable of obviating the cited limitations of the background art.

In particular, the disclosure provides a motorized wheel that has reduced components and simplified assembly.

The disclosure further provides a motorized wheel having a modifiable axial volume in order to adapt better to the assembly spaces available.

Also, the disclosure provides a motorized wheel the functionality of which is not lower than that of known motorized wheels.

This aim and these and other objects that will become better apparent hereinafter are achieved by a motorized wheel, of the type comprising an electric motor supported by a fixing bracket and adapted to support rotationally, by way of means for reducing the rotation rate, an internally hollow wheel that is contoured to contain at least partly said electric motor and said rotation rate reduction means, said electric motor comprising a stator casing, a dome and a rotor which is internal to said stator casing, said motorized wheel being characterized in that said stator casing is inserted in a corresponding complementarily shaped annular portion that extends from said bracket and is fixed thereto by interference.

Further characteristics and advantages of the disclosure will become better apparent from the description of a preferred but not exclusive embodiment of the motorized wheel according to the disclosure, illustrated by way of non-limiting example in the accompanying drawings, wherein:

### BRIEF DESCRIPTION OF THE DRAWINGS

FIG. 1 is a sectional side view of a conventional motorized wheel;

FIG. 2 is a perspective view of a motorized wheel according to the disclosure;

FIG. 3 is a perspective view of a detail of the motorized wheel according to the disclosure;

FIG. 4 is a sectional side view of the motorized wheel according to the disclosure;

FIG. 5 is a sectional side view of the detail of FIG. 3;

FIGS. 6 and 7 are each a view of a different setup of the motorized wheel according to the disclosure.

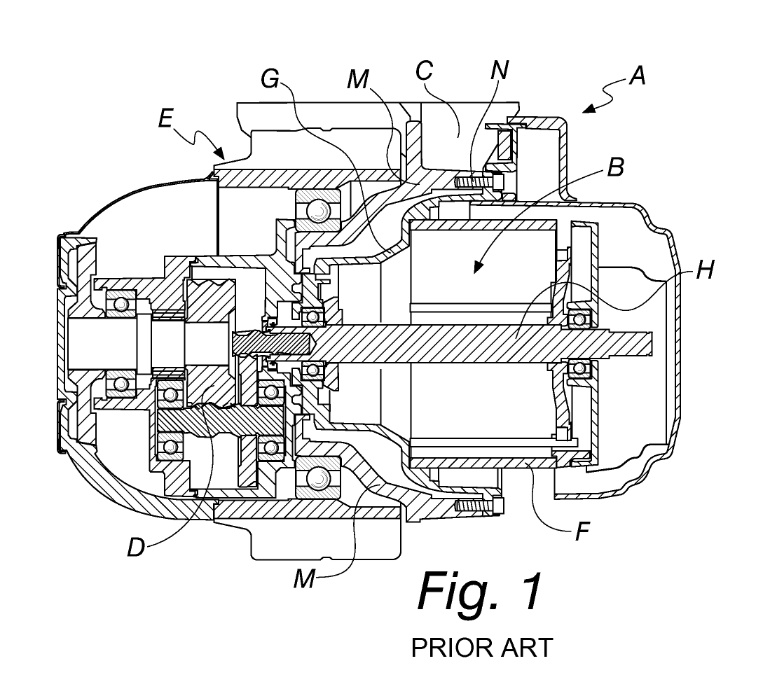

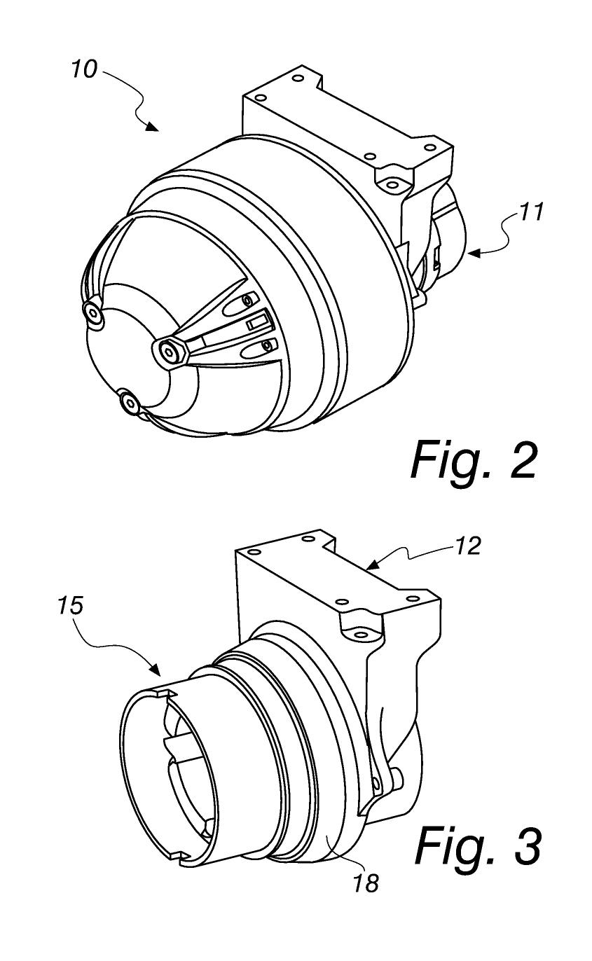

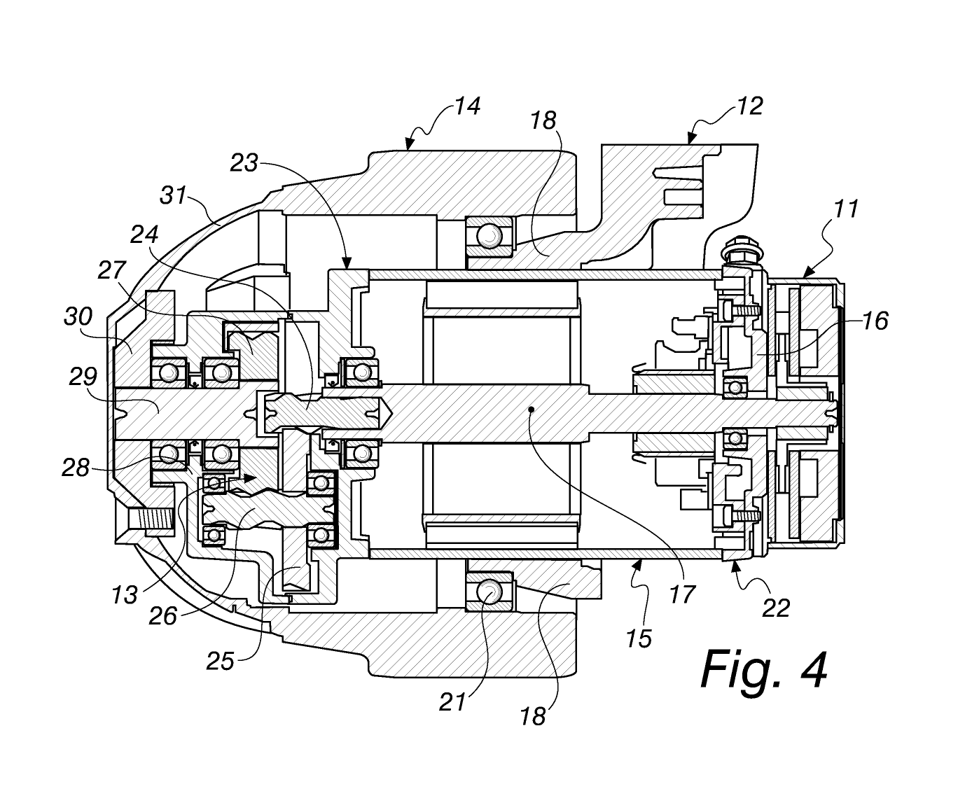

### DETAILED DESCRIPTION OF THE DRAWINGS

With reference to the figures, a motorized wheel according to the disclosure is generally designated by the reference numeral 10.

The motorized wheel 10 is of the type comprising an electric motor 11, for example, but not exclusively, a direct-current motor, supported by a fixing bracket 12, adapted to support rotationally, by way of means 13 for reducing the rotation rate, an internally hollow wheel 14 that is contoured to contain partly the electric motor 11 and the rotation rate reduction means 13.

The electric motor 11 comprises a stator casing 15, for example, but not exclusively, a stator casing supporting a plurality of permanent magnets, and a dome 16, for example a brush-holder dome, and a rotor which is internal to said stator casing 15, of which, for sake of simplicity, only the shaft 17 is shown.

The particularity of the motorized wheel 10 according to the disclosure resides in that the stator casing 15 is inserted in a corresponding complementarily shaped annular portion 18 that extends from the bracket 12, in a single body therewith, and is fixed to the annular portion 18 by interference.

The stator casing 15 is constituted by a tubular cylinder made of metallic material.

In particular, the interference is obtained by hot-keying the stator casing 15, made of metallic material, in the annular portion 18 of the bracket 12, also made of metallic material, for example aluminum.

A method for fixing by interference the stator casing 15 to the fixing bracket 12 comprises therefore the following operations.

The bracket 12, with the annular portion 18, is heated so as to allow the insertion of the stator casing 15 in the annular portion 18.

Once the stator casing and the annular portion have been coupled, one proceeds to cool the annular portion 18, which tightens onto the stator casing 15, producing fixing by interference.

This mechanical coupling ensures both resistance to the torque transmitted by the electric motor and the electrical proprieties of the magnetic flux that are typical of the stator casing 15.

As an alternative, interference is obtained by cold keying; in this case one operates by inserting the casing of the electric motor 11 in the annular portion 18 of the bracket 12, applying a preset pressure and thus producing fixing by interference.

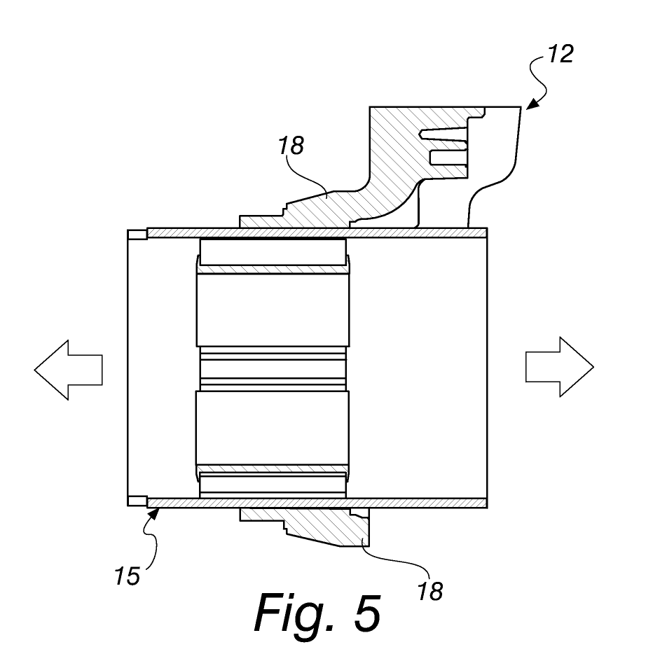

FIG. 5 clearly shows that with this system for fixing by interference, the position in the axial direction of the stator casing 15 with respect to the bracket 12 can be different according to the volumes that one intends to provide.

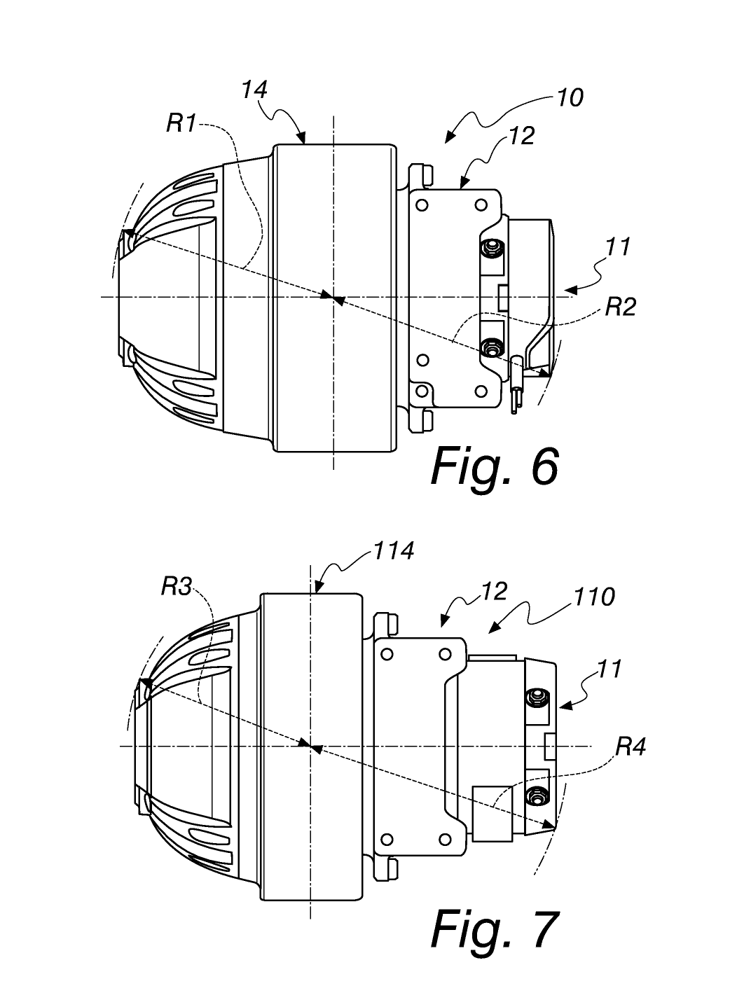

FIG. 6 shows a motorized wheel with the stator casing, and therefore the electric motor 11, arranged with respect to the bracket 12 so as to have a motorized wheel 10 having a volume defined by a so-called first radius of curvature R1 and by a second radius of curvature R2, centered in the intersection of the tread axis and in the rotation axis of the electric motor.

FIG. 7 shows the same motorized wheel 110 with the stator casing, and therefore the electric motor 11, arranged more externally with respect to the bracket 12, so as to have a motorized wheel 110 having a volume defined by a so-called first radius of curvature R3 and by a second radius of curvature R4, with R3 smaller than R1 and R4 greater than R2 as in FIGS. 6 and 7.

Therefore, by simply modifying the relative position of the bracket 12 and the stator casing 15 it is possible to provide models of motorized wheel having different volumes, according to the assembly needs and requirements.

The hollow wheel 14 rests on the underlying annular portion 18 of the bracket 12 by interposition of friction reduction means, such as a ball bearing 21.

The stator casing 15 is closed by two covers, a first external cover 22, which in the present example of DC electric motor 11 comprises the brush-holder dome 16, and a second internal cover 23, which contoured on the opposite side with respect to the electric motor 11, in order to support a portion of the rotation rate reduction means 13.

The same structure that comprises a stator casing with two covers is obviously to be understood as referable also to an AC electric motor of a constructive variation of a motorized wheel according to the disclosure, a variation that is not illustrated for the sake of simplicity.

The rotation rate reduction means 13 comprise a first pinion 24, which is fixed to the end of the shaft 17 of the electric motor 11, a first reduction gear 25, the axis of which is parallel to the axis of the electric motor 11, which in turn supports coaxially a second pinion 26 that meshes with a second reduction gear 27 which is coaxial to the shaft 17 of the electric motor 11.

The second reduction gear 27 is supported by a case 28 for protecting the rotation rate reduction means 13; the case 28 is fixed to the second cover 23.

A wheel supporting flange 30 is fixed on the rotation shaft 29 of the second reduction gear 27 and an external dome 31 is fixed to said flange and in turn is integral with the hollow wheel 14 for transmitting thereto the rotation.

In practice it has been found that the disclosure achieves the intended aim and objects.

In particular, the disclosure provides a motorized wheel which, thanks to the fixing by interference of the stator casing in the annular portion of the bracket, allows to eliminate any fixing with screws between the bracket and the electric motor.

Moreover, the disclosure provides a motorized wheel that can be assembled without the intermediate component typical of conventional motorized wheels, since the stator casing is fixed directly to the bracket, with consequent saving in terms of components as well as of assembly times.

Furthermore, the disclosure provides a motorized wheel in which the fixing of the rotation rate reduction means directly to the stator casing allows better centering of the first pinion, fixed to the motor shaft, with respect to the first reduction gear; in the background art described above, the bracket is interposed between the stator casing and the reduction means, with consequent centering errors that are inherent in the production process.

Moreover, thanks to this technical solution, the disclosure has developed a motorized wheel that can be assembled with an important reduction of assembly times with respect to conventional motorized wheels.

The motorized wheel according to the disclosure is consequently also lighter than similar conventional motorized wheels.

Further, the disclosure provides a motorized wheel that is easy to assemble so as to originate different models simply by modifying the fixing position of the stator casing with respect to the fixing bracket.

Therefore, the variability of arrangement of the casing allows to manage in a very flexible manner the radius of curvature of the motorized wheel according to the customer's requirements, simply by translating said casing axially.

The disclosure thus conceived is susceptible of numerous modifications and variations; all the details may further be replaced with other technically equivalent elements.

In practice, the components and the materials used, so long as they are compatible with the specific use, as well as the contingent shapes and dimensions, may be any according to requirements and to the state of the art.

The disclosures in Italian Patent Application No. PD2014A000143 from which this application claims priority are incorporated herein by reference.

1. A motorized wheel, comprising an electric motor supported by a fixing bracket, adapted to rotationally support, by way of means for reducing the rotation rate, an internally hollow wheel that is contoured to contain at least partly said electric motor and said rotation rate reduction means, said electric motor includes a stator casing, a dome and a rotor which is internal to said stator casing, wherein said stator casing is inserted in a corresponding complementarily shaped annular portion that extends from said bracket and is fixed to the bracket by interference.

2. The motorized wheel according to claim 1, wherein said stator casing is constituted by a tubular cylinder made of metallic material.

3. The motorized wheel according to claim 1, wherein said bracket is disposed in a single body with said annular portion and is made of metallic material, for example aluminum.

4. The motorized wheel according to claim 1, wherein said interference is obtained by hot-keying the stator casing in the annular portion of the bracket.

5. A method for fixing by interference a stator casing of an electric motor to a fixing bracket of a motorized wheel according to claim 1, including the following method steps:
heating the bracket, with the annular portion, so as to allow the insertion of the stator casing in the annular portion,
once the stator casing and the annular portion are mated, proceeding with the cooling of the annular portion, which tightens onto the stator casing, producing fixing by interference.

6. The method for fixing by interference a stator casing of an electric motor to a fixing bracket of a motorized wheel according to claim 5, wherein the interference is obtained by cold keying, by inserting the casing of the electric motor in the annular portion of the bracket and applying a preset pressure.
